(19) United States
(12) Patent Application Publication
(10) Pub. No.: US 2005/0006568 A1
(43) Pub. Date: Jan. 13, 2005

(54) Auto on/ off plug

(76) Inventor: G.C. Harned, Carrollton, TX (US)

Correspondence Address: G.C. HARNED, PMB 114-173, 4009 OLD DENTON RD, CARROLLTON, TX, 75007, US

(21) Appl. No.: 10/614,706

(22) Filed: Jul. 7, 2003

(51) Int. Cl. H01J 40/14

(52) U.S. Cl. 250/221

(57) ABSTRACT

The Eye Plug is a standard outlet modified to allow it to turn on and off by light. On at dark and off at dawn. The Eye Plug allows for a vacationer to not worry about resetting timers when away due to power outage. The outlet will control seasonal lighting without fancy timers that need to be set and re set. There is no product/plug that will allow this. Safety, ease of use, usable for all consumers. Use for vacation lamps, outdoor lighting, or seasonal lights and when not needed override and use as a normal plug. No modification is needed to the home simply replace existing plug with the Eye Plug.

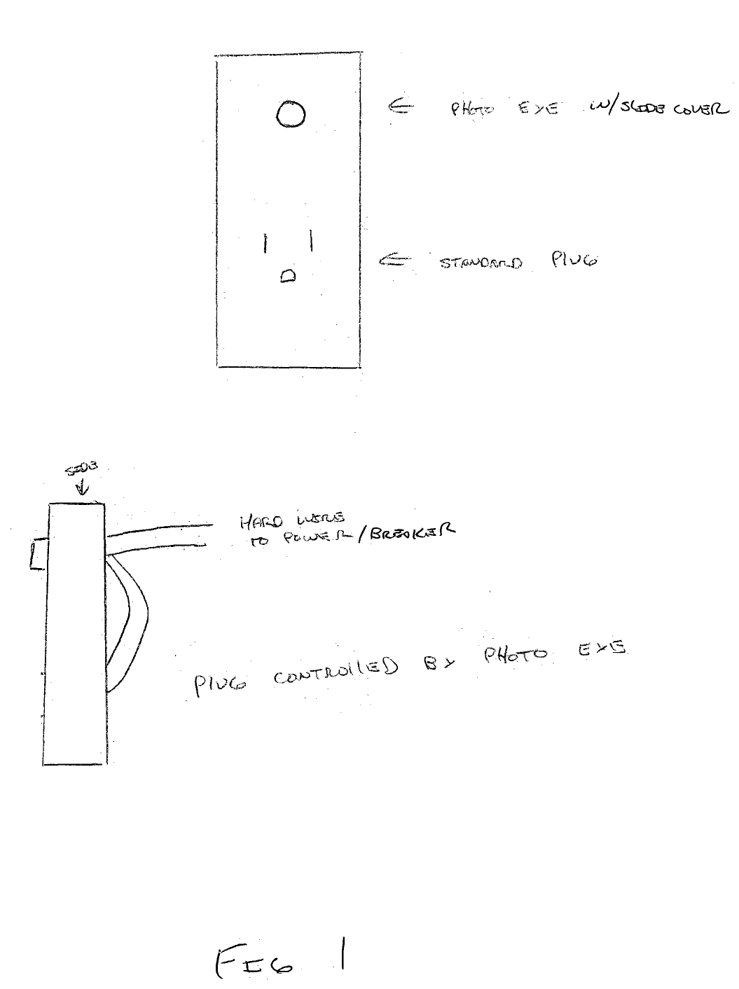

Electrical outlet that is turned on automatically at dusk and off at dawn. Application is exterior lighting, safety lighting, holiday lighting, indoor lighting when on vacation, etc.

Timers have to be reset on power failure so are not 100% reliable. This product is hard wired to power and will turn on when darkness falls and off at daylight.

1. (Cancel)

2. The Auto on/off plug is a electrical outlet that is controlled by light and dark or can be used as a standard outlet using the light blocking cover; the plug is controlled with a photo sensor to turn on/off and can be used to control items such as outside lighting, holiday lights, lamps, etc without having to turn on/off a switch; since this item does not operate by timer even during a power outage there is no need to reset as you would a standard electrical timer thereby when on vacation the lights would continue to operate from dusk to dawn providing added security to home or office; any standard plug will be able to be replaced with the Auto Plug with no added wiring needed and can be used indoor or out.
